(19) United States
(12) Patent Application Publication
(10) Pub. No.: US 2017/0261805 A1
(43) Pub. Date: Sep. 14, 2017

(54) MANUFACTURING METHOD OF ARRAY SUBSTRATE, TRNASLUCENT PASSIVATION FILM AND LIQUID CRYSTAL DISPLAY PANEL

(71) Applicant: Shenzhen China Star Optoelectronics Technology Co., Ltd., Shenzhen, Guangdong (CN)

(72) Inventor: Yang ZHAO, Shenzhen, Guangdong (CN)

(73) Assignee: Shenzhen China Star Optoelectronics Technology Co., Ltd., Shenzhen, Guangdong (CN)

(21) Appl. No.: 14/913,364

(22) PCT Filed: Dec. 31, 2015
(86) PCT No.: PCT/CN2015/100188

§ 371 Date: Feb. 20, 2016

(30) Foreign Application Priority Data
Sep. 25, 2015 (CN) 2015106246584

(51) Int. Cl. G02F 1/1333; G02F 1/1362; G02F 1/1343

(52) U.S. Cl. CPC G02F 1/133345; G02F 1/13439; G02F 1/136227; G02F 2201/121; G02F 2201/123; G02F 2001/134372; G02F 1/1368

(57) ABSTRACT

This disclosure discloses a method of manufacturing an array substrate. The method includes forming a first translucent conductive film on a substrate, forming a translucent passivation film on the first translucent conductive film at a temperature lower than 200° C.; and forming a second translucent conductive film on the translucent passivation film. This disclosure also discloses a method of manufacturing a translucent passivation film and a liquid crystal display panel. The particle-like bumps would be reduced and the light transmission rate of the liquid crystal display panel would be improved.

### TECHNICAL FIELD

This disclosure is related to the liquid crystal display panel, especially related to a manufacturing method of an array substrate, a translucent passivation film and a liquid crystal display panel

### DESCRIPTION OF RELATED ART

In the Fringe Field Switching (FFS) type of LCD panel, there are three thin films on an array substrate. The three thin films are a common electrode, a passivation layer and a pixel electrode accordingly. In the conventional manufacturing process, the passivation film is formed by sputtering at a temperature which is higher than 285° C. However, the topology of the top surface of the passivation layer would be bumpy due to the high activity of the passivation material while the high temperature process. The light transmission ratio would be reduced.

### SUMMARY

To solve the issues mentioned above, the embodiments of the present disclosure provide a manufacturing method of an array substrate, a translucent passivation film and a liquid crystal display panel to reduce the bumps on the top surface of the passivation film and improve the light transmission rate of the liquid crystal display panel.

In one embodiment of the present disclosure, a method of manufacturing an array substrate is provided, which comprises forming a first translucent conductive film on a substrate, forming a translucent passivation film on the first translucent conductive film at a temperature lower than 200° C., and forming a second translucent conductive film on the translucent passivation film.

In another embodiment of the present disclosure, the step of forming the first transparent conductive film on the substrate further comprises:

forming the first translucent conductive film at a first predetermined temperature; and annealing the first translucent film, wherein the first predetermined temperature is higher than 200° C.

In the other embodiment of the present disclosure, the step of forming the first translucent conductive film on the substrate further comprises forming the first translucent conductive film in a non-heating status.

In the other embodiment of the present disclosure, the step of forming the second translucent conductive film on the translucent passivation film further comprises forming the second translucent conductive film on the translucent passivation film at a second predetermined temperature; and annealing the second translucent film, and the second predetermined temperature is higher than 200° C..

In the other embodiment of the present disclosure, the first predetermined temperature is the same as the second predetermined temperature.

In the other embodiment of the present disclosure, the step of forming the second translucent conductive film on the translucent passivation film further comprises forming the second translucent conductive film on the transparent passivation film in a non-heating status.

In the other embodiment of the present disclosure, the step of forming the translucent passivation film on the first translucent conductive film at a temperature lower than 200° C. further comprises a contact hole is formed in the translucent passivation film; and the second translucent film is electrically connected with a source or a drain of the substrate by the contact hole.

In the other embodiment of the present disclosure, the first translucent conductive film is a common electrode, and the second translucent conductive film is a pixel electrode.

Another embodiment of present disclosure also provides a method of manufacturing a translucent passivation layer between a common electrode and a pixel electrode and the common electrode is located on an array substrate, comprising forming the translucent passivation layer on the common electrode at a temperature lower than 200° C.

In another embodiment of the present disclosure, the method further comprises forming the common electrode at a first predetermined temperature; and annealing the common electrode, wherein the first predetermined temperature is higher than 200° C.

In the other embodiment of the present disclosure, the method further comprises forming the common electrode in a non-heating status.

In the other embodiment of the present disclosure, the method further comprises forming the pixel electrode on the translucent passivation film at a second predetermined temperature; and annealing the pixel electrode, wherein the second predetermined temperature is higher than 200° C.

In the other embodiment of the present disclosure, the first predetermined temperature is the same as the second predetermined temperature.

In the other embodiment of the present disclosure, the method further comprises forming the pixel electrode on the transparent passivation film in a non-heating status.

In the other embodiment of the present disclosure, the method further comprises forming a contact hole in the translucent passivation film; and electrically connecting the pixel electrode with a source or a drain of the array substrate by the contact hole.

Another embodiment of present disclosure also provides a method of manufacturing a liquid crystal display panel, comprises forming a common electrode on the substrate; forming a translucent passivation film on the common electrode at a temperature lower than 200° C.; and forming a pixel electrode on the translucent passivation film.

The present disclosure provides a manufacturing method of an array substrate, a translucent passivation film and a liquid crystal display panel to reduce the bumps on the top surface of the passivation film and improve the light transmission rate of the liquid crystal display panel.

### BRIEF DESCRIPTION OF THE DRAWINGS

The disclosure is best understood from the following detailed description when read in connection with the accompanying drawings, which illustrate an embodiment of the present disclosure:

FIG. 1 is the schematic of manufacturing flow of an array substrate of one embodiment of the present disclosure.

FIG. 2 is the schematic cross-view of the structure of the array substrate in the embodiment of the present disclosure.

FIG. 3 is the schematic of manufacturing flow of an array substrate of another embodiment of the present disclosure.

FIG. 4 is the schematic cross-view of the structure of the array substrate in the other embodiment of the present disclosure.

### DETAILED DESCRIPTION OF EMBODIMENTS

The present disclosure will now be described more specifically with reference to the following embodiments. It is to be noted that the following descriptions of embodiments are presented herein for purpose of illustration and description only. It is not intended to be exhaustive or to be limited to the precise form disclosed.

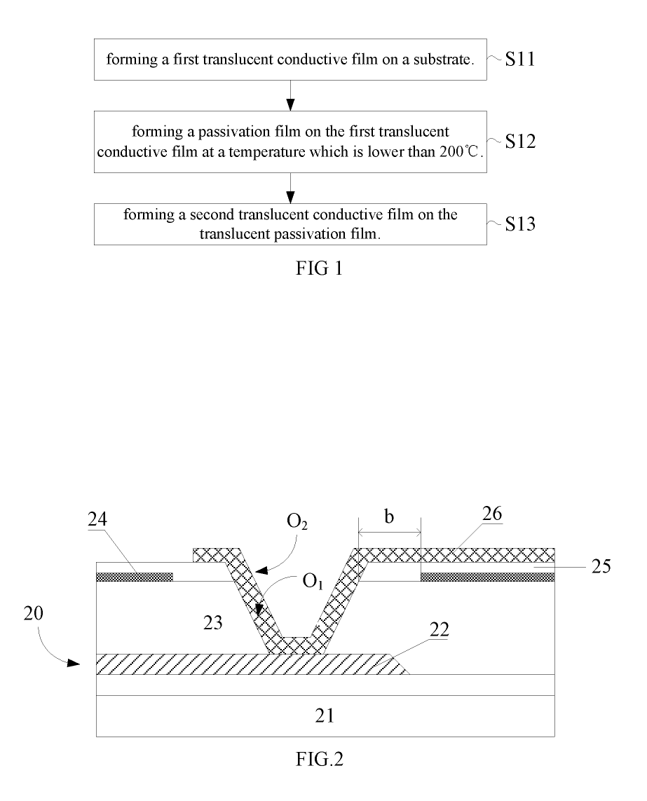

FIG. 1 is the schematic of manufacturing flow of an array substrate of one embodiment of the present disclosure. This embodiment is to manufacture a structure with three films, which includes a first translucent conductive film, a passivation film, and a second translucent film. With reference to FIG. 1, the manufacturing process comprises:

S11: forming a first translucent conductive film on a substrate.

S12: forming a passivation film on the first translucent conductive film at a temperature which is lower than 200° C.

S13: forming a second translucent conductive film on the translucent passivation film.

The materials of the first translucent conductive film and the second translucent conductive film could be the same, such as Indium Tin Oxide (ITO) transparent conductive film. The translucent passivation film is a thin film which is electrically isolated and light transmissive. In an embodiment in the FFS type liquid crystal display panel, the first translucent conductive film is a common electrode, and the second translucent conductive film is a pixel electrode. Accordingly, the translucent passivation film is formed between the common electrode and the pixel electrode to act as a passivation layer (PV layer).

In the conventional technology, the translucent passivation layer is formed by sputtering at a high temperature which is higher than 285° C. In the embodiments of the present disclosure, the translucent passivation layer is formed at a temperature which is lower than 200° C. Low temperature can lower the activity of the particle of the passivation material and reduce the bumps formed on the surface of the passivation layer. Accordingly, the light transmission rate of the liquid crystal display panel is improved.

To be specific, the structure with the three thin films in not necessary to apply on the array substrate directly. In other words, there could be other films formed between the array substrate and the first translucent conductive layer. FIG. 2 is the schematic cross-view of the structure of the array substrate in the embodiment of the present disclosure.

With reference to FIG. 2, the array substrate 20 comprises a substrate 21, a metal layer 22, a first passivation layer 23, a common electrode 24, a second passivation layer 25 and a pixel electrode 26. The metal layer 22 is formed on the substrate 21. The first passivation layer 23 is formed on the metal layer 22, and a first contact hole O1 is formed in the first passivation layer 23 to expose the metal layer 22. The common electrode 24 is formed on the first passivation layer 23 and outside the first contact hole O1. In other words, the common electrode 24 doesn't cover the contact hole O1 and the zone (illustrated as “b”) near the first contact hole O1. A second hole O2 is formed in the second passivation layer 25. The first contact hole O1 and the second contact hole O2 are connected with each other to form a contact hole. The pixel electrode 26 is applied in the contact hole which is assembled with the first contact hole O1 and the second contact hole O2 to electrically connect with the metal layer 22. The metal layer 22 could be one of the drain or source of the array substrate. In other words, a contact hole is formed in the translucent passivation film and electrically connected with a drain or a source of the array substrate 20.

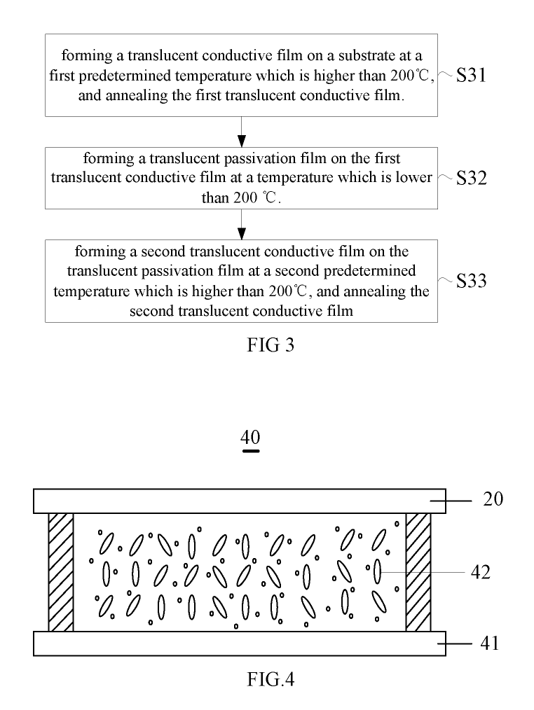

FIG. 3 is the schematic of manufacturing flow of an array substrate of another embodiment of the present disclosure. The method comprises:

S31 forming a translucent conductive film on a substrate at a first predetermined temperature which is higher than 200° C., and annealing the first translucent conductive film.

S32: forming a translucent passivation film on the first translucent conductive film at a temperature which is lower than 200° C.

S33: forming a second translucent conductive film on the translucent passivation film at a second predetermined temperature which is higher than 200° C., and annealing the second translucent conductive film.

The first predetermined temperature could be the same as the second predetermined temperature or not. However, both of them shall be higher than 200° C. In other words, the temperature of forming the first translucent conductive film and the second conductive film is higher than the temperature of forming the translucent passivation film.

In some embodiments of the present disclosure, the first translucent conductive film, the translucent passivation film and the second translucent conductive film can be formed by one or the combination of a group consisting of sputtering, Plasma Enhanced Chemical vapor deposition (PECVD), Chemical vapor deposition (CVD), Low Pressure Chemical vapor deposition (LPCVD) and vacuum evaporation deposition.

The transmission rate of the translucent passivation film which is formed at 285° C. after annealing with 400 Å thickness is 43.76%. Instead, The transmission rate of the translucent passivation film which is formed at 200° C. after annealing with 400 Å thickness is 88.33%. Similarly, the transmission rate of the translucent conductive film which is formed at 28° C. after annealing with 400 Å thickness is 48.12%. Instead, The transmission rate of the translucent conductive film which is formed at 200° C. after annealing with 400 Å thickness is 75.39%.

Apparently, applying the manufacturing method in the liquid crystal display panel, the light transmission rate is improved.

In some other embodiments, the first translucent conductive film can be formed in a non-heating status. Similarly, the second translucent conductive film can be formed in a non-heating status. For example, the light transmission rate of the liquid crystal display panel with the annealed 400 Å first translucent conductive film formed in a non-heating status and, the translucent passivation film formed at 200° C. and the annealed 400 Å second translucent conductive film formed in a non-heating status is 76.13%. It's apparently improved to compare with the conventional device.

FIG. 4 is the schematic cross-view of the structure of the array substrate in the other embodiment of the present disclosure. The liquid crystal display panel 40 comprises an array substrate 20, a color filter 41 disposed in opposite of the array substrate 20, and liquid crystal 42 disposed between the array substrate 20 and the color filter 41. The method of manufacturing the liquid crystal display panel 40 includes the method of manufacturing the array substrate 20 mentioned above.

Another embodiment of present disclosure also provides a method of manufacturing a translucent passivation layer. The translucent passivation layer is similar with the second passivation layer 25 between the common electrode 24 and the pixel electrode 26 illustrated in FIG. 2. Therefore, the translucent passivation layer can be form on the common electrode 24 at a temperature which is less than 200° C.

Although the description above contains many specificities, these should not be construed as limiting the scope of the embodiment but as merely providing illustrations of some of the presently preferred embodiments. Rather, the scope of the disclosure is to be determined only by the appended claims and their equivalents.

What is claimed is:

1. A method of manufacturing an array substrate, comprising:
forming a first translucent conductive film on a substrate;
forming a translucent passivation film on the first translucent conductive film at a temperature lower than 200° C.; and
forming a second translucent conductive film on the translucent passivation film.

2. The method according to claim 1, wherein the step of forming the first transparent conductive film on the substrate further comprises:
forming the first translucent conductive film at a first predetermined temperature; and
annealing the first translucent film, wherein the first predetermined temperature is higher than 200° C.

3. The method according to claim 1, wherein the step of forming the first translucent conductive film on the substrate further comprises:
forming the first translucent conductive film in a non-heating status.

4. The method according to claim 1, wherein the step of forming the second translucent conductive film on the translucent passivation film further comprises:
forming the second translucent conductive film on the translucent passivation film at a second predetermined temperature; and
annealing the second translucent film, wherein the second predetermined temperature is higher than 200° C.

5. The method according to claim 4, wherein the first predetermined temperature is the same as the second predetermined temperature.

6. The method according to claim 1, wherein the step of forming the second translucent conductive film on the translucent passivation film further comprises:
Forming the second translucent conductive film on the transparent passivation film in a non-heating status.

7. The method according to claim 1, wherein the step of forming the translucent passivation film on the first translucent conductive film at a temperature lower than 200° C. further comprises:
a contact hole is formed in the translucent passivation film; and
the second translucent film is electrically connected with a source or a drain of the substrate by the contact hole.

8. The method according to claim 1, wherein the first translucent conductive film is a common electrode, and the second translucent conductive film is a pixel electrode.

9. A method of manufacturing a translucent passivation layer between a common electrode and a pixel electrode and the common electrode is located on an array substrate, comprising:
forming the translucent passivation layer on the common electrode at a temperature lower than 200° C.

10. The method according to claim 9, further comprising:
forming the common electrode at a first predetermined temperature; and
annealing the common electrode, wherein the first predetermined temperature is higher than 200° C.

11. The method according to claim 9, further comprising forming the common electrode in a non-heating status.

12. The method according to claim 9, further comprising:
forming the pixel electrode on the translucent passivation film at a second predetermined temperature; and
annealing the pixel electrode, wherein the second predetermined temperature is higher than 200° C.

13. The method according to claim 12, wherein the first predetermined temperature is the same as the second predetermined temperature.

14. The method according to claim 9 further comprising forming the pixel electrode on the transparent passivation film in a non-heating status.

15. The method according to claim 9 further comprising:
forming a contact hole in the translucent passivation film; and
electrically connecting the pixel electrode with a source or a drain of the array substrate by the contact hole.

16. A method of manufacturing a liquid crystal display panel, comprising:
forming a common electrode on the substrate;
forming a translucent passivation film on the common electrode at a temperature lower than 200° C.; and
forming a pixel electrode on the translucent passivation film.
